(19) United States
(12) Patent Application Publication
(10) Pub. No.: US 2008/0242430 A1
(43) Pub. Date: Oct. 2, 2008

(54) Power transmission device

(75) Inventors: Michiyasu Nosaka, Anjo-city (JP); Yoshiki Tada, Okazaki-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/076,870

(22) Filed: Mar. 25, 2008

(30) Foreign Application Priority Data
Mar. 27, 2007 (JP) 2007-081553

(51) Int. Cl. F16D 7/02

(52) U.S. Cl. 464/30

(57) ABSTRACT

A power transmission device 41, in which a spacer 69 is press-fitted around a rear side of a male thread section 63 of an input shaft 57. An adapter 83 is screwed to the male thread section 63 of the input shaft 57 and its large diameter section 89 abuts against a large diameter section 77 of the spacer 69. A hub 99 abuts against a front side of the large diameter section 89 of the adapter 83. A power interruption member 113 has a flange section 119 abutting against the hub 99, and a tubular section 117 screwed to an outer circumference of the adapter 83. It is configured so that a friction coefficient μw1 between the large diameter section 89 of the adapter 83 and an inner circumference of the hub 99 is smaller than a friction coefficient μw2 between the large diameter section 89 of the adapter 83 and the large diameter section 77 of the spacer 69. The adapter is re-press-fitted around the adapter so that when excessive torque occurs, power transmission can be reliably interrupted when torque reaches a predetermined level.

### BACKGROUND OF THE INVENTION

1. Field of the Invention

The present invention relates to a power transmission device that transmits power from an external power source to a driven apparatus and that has a torque limiter.

2. Description of the Related Art

Typically, a compressor for an automobile air conditioner that receives power transmitted from an external power source such as an engine and the like via a belt, a pulley and the like is provided with a power transmission device that is disposed between the belt and an input shaft of the compressor and that can interrupt the power when excessive torque occurs.

As an example of the power transmission device of this type, a known power transmission device is disclosed in Japanese Unexamined Patent Publication No. 2006-292042 and it is shown in FIGS. 19 and 20. This power transmission device 11 has: a pulley 17 that is rotatably mounted on a compressor housing 13 via a bearing 15; and an input shaft 19 that is supported on the housing 13. A male thread section 21 is formed at a front side of the input shaft 19 and a tubular adapter 23 is fitted around the input shaft 19. This adapter 23 has a female thread section 25 on its front-side inner circumferential surface and press-fitted around the input shaft 19 so that the female thread section 25 is screwed with the male thread section 21 of the input shaft 19.

A male thread section 27 is formed on a front-side outer circumference of the adapter 23 and a spool section 29a of a power interruption member 29 is screwed to the male thread section 27. On the other hand, a large diameter section 31 is provided on a rear-side outer circumference of the adapter 23 and a hub 33 abuts against a front side of the large diameter section 31. Then, the power interruption member 29 is screwed so that an outer circumference 29b of the power interruption member 29 presses the hub 33 against the large diameter section 31 to transmit the power from the hub 33 to the adapter 23.

A hub-side concavo-convex section 35 is formed on an outer circumference of the hub 33, and the hub-side concavo-convex section 35 is engaged with a pulley-side concavo-convex section 37 formed on the pulley 17.

Then, the power transmitted to the pulley 17 by a belt and the like is transmitted to the input shaft 19 via the hub 33 and the adapter 23.

On the other hand, when an excessive load is applied due to seizure of the compressor and the like, relative rotation occurs between the power interruption member 29 and the adapter 23 and this relative rotation applies a large tensile force between the outer circumference 29b and the spool section 29a of the power interruption member 29 and ruptures the power interruption member 29. As a result, the hub 33 is not pressed against the large diameter section 31 of the adapter 23 so as to interrupt the power transmission and prevent damage to the power source.

In the power transmission device 11 described above, under normal operation of the air conditioner, an axial force in an axial direction generated in the thread screwed sections by power transmission torque is supported by the adapter 23. Therefore, when an excessive torque is generated due to the seizure of the compressor and the like, a portion of the adapter 23 that is press-fitted around the input shaft 19 elastically deforms and causes re-press-fitting.

When the re-press-fitting occurs in this portion, as shown in Japanese Unexamined Patent Publication No. 2003-35255, an axial tensile force to be applied to the power interruption member 29 dissipates, and therefore, there is a problem in that, even though the torque exceeds a predetermined level, a limiter does not work and the power transmission cannot be interrupted.

Further, when the re-press-fitting occurs, the adapter 23 and, as a consequence, the hub 33 moves rearward. Therefore, there is another problem in that the hub 33 presses the pulley 17 rearward to apply a thrust load to the bearing 15 so as to significantly reduce durability of the bearing.

Still further, for example, in a construction in which the hub 33 is engaged with the pulley 17 via an elastic member, there is yet another problem in that the hub 33 interferes with the pulley 17.

### SUMMARY OF THE INVENTION

The present invention has been made to solve the above-mentioned problems and provides a power transmission device that can prevent an adapter from being re-press-fitted around an input shaft, and therefore, can reliably interrupt power transmission when torque reaches a predetermined level.

In order to solve the above-mentioned problems, according to the present invention, there is provided a power transmission device comprising: an input shaft (57) having a male thread section (65) on its front-side outer circumference; a spacer (69) press-fitted and secured around a rear-side of the male thread section (65) of this input shaft (57); a tubular adapter (83) screwed to the male thread section (65) of the input shaft (57) and friction-coupled with a front side of the spacer (69), tubular adapter (83) having a male thread section (93) on its outer circumference; a hub (99) having an inner circumference (101) being friction-coupled with a front side of the adapter (83) to transmit external power to the adapter (83); and a power interruption section (113) having a flange section (119) engaged with the hub (99) and a tubular section (117) screwed to the male thread section (93) of the adapter (83), said power interruption section pressing the inner circumference of the hub (99) against the adapter (83) to transmit power from the hub (99) to the input shaft (57), wherein, in the power interruption section (113), when an excessive load is applied to a driven apparatus, the tubular section (117) rotates with respect to the adapter (83) to apply a tensile force between the tubular section (117) and the flange section (119) to rupture the tubular section (117) from the flange section (119), so that a pressing force on the adapter (83) is dissipated and power is interrupted, wherein, when an excessive torque is applied, even if the friction coupling (151) between the adapter (83) and the inner circumference (101) of the hub (99) starts to slip, the friction coupling (153, 203, 311) between the adapter (83) and the spacer (69) does not slip.

In this power transmission device, even if excessive torque is applied and a large axial force is applied to the power interruption member (113) on the adapter (83), so long as the adapter (83) and the spacer (69) do not slip with respect to each other, the axial force is not affected to the adapter (83), and therefore, in contrast to the conventional art, re-press-fitting of the press-fitted adapter can be prevented. Further, when excessive torque is applied, even if the adapter (83) and the inner circumference (101) of the hub (99) start to slip with respect to each other, the adapter (83) and the spacer (69) do not slip with respect to each other, and therefore, the relative rotation between the adapter (83) and the power interruption member (113) can be reliably caused to break the power interruption member (113).

Further, according to the present invention, assuming that an abutment surface (151) between the adapter (83) and the inner circumference (101) of the hub (99) has an equivalent friction diameter dw1 and a friction coefficient μw1 and an abutment surface (153) between the adapter (83) and the spacer (69) has an equivalent friction diameter dw2 and a friction coefficient μw2, if dw1 and dw2 are substantially comparable to each other, a relationship μw1<μw2 may be established. Therefore, even if the equivalent friction diameters are comparable to each other, when excessive torque is applied, abutment surface (153) can be prevented from slipping before the abutment surface (151) and the power interruption mechanism can work properly.

More specifically, a front-side adapter bearing surface (95) abutting against the inner circumference (101) of the hub (99) may be smoother than a rear-side adapter bearing surface (97) abutting against the spacer, (69) and further, a surface treatment may be applied to the front side adapter bearing surface (95) so that the front side adapter bearing surface (95) is smoother than the rear-side adapter bearing surface (97).

Still further, according to the present invention, a washer (203) may be disposed between the adapter (83) and the spacer (69). Therefore, even if the perpendicularity and flatness of the rear-side adapter bearing surface of the adapter (83) with respect to the axis line is somewhat uneven, or perpendicularity and flatness of the front-side bearing surface of the spacer (69) with respect to the axis line is somewhat uneven, the washer (203) can absorb the unevenness, and therefore, damage and wear of the parts due to an unbalanced load, partial contact and the like can be prevented.

Still further, according to the present invention, assuming that an abutment surface (151) between the adapter (83) and the inner circumference (101) of the hub (99) has an equivalent friction diameter dw1 and a friction coefficient μw1, a contact surface (207) between the adapter (83) and the washer (203) has an equivalent friction diameter dw3 and a friction coefficient μw3, and a contact surface (211) between the washer (203) and the spacer (69) has an equivalent friction diameter dw4 and a friction coefficient μw4, when dw1, dw3 and dw4 are substantially comparable to each other, a relationship μw1<μw3 and μw1<μw4 may be established. Therefore, even if the equivalent friction diameters dw1, dw3 and dw4 are comparable to each other, when excessive torque is applied, the contact surfaces (207, 211) can be prevented from slipping before the abutment surface (151) and the power interruption mechanism can work properly.

Still further, according to the present invention, an abutment surface (311) between the adapter (83) and the spacer (69) may be tapered. Therefore, when an excessive axial force is applied due to seizure of a compressor and the like, the tapered surfaces are strongly fitted into each other to increase binding force and, due to a wedge effect of the tapered surfaces, unevenness of the abutment surface can be corrected and occurrence of the unbalanced load can be prevented.

More specifically, the abutment surface (311) may be formed to increase its diameter from its front side toward its rear side, or the abutment surface (311) may be formed to reduce its diameter from its front side toward its rear side.

Hereinabove, reference numerals in parentheses affixed to the above means are examples showing correspondence with specific means set forth in embodiments described below.

### BRIEF DESCRIPTION OF THE DRAWINGS

In the drawings:

FIG. 1 is a longitudinal cross-sectional view showing a power transmission device that is a first embodiment of the present invention;

FIG. 2 is a longitudinal cross-sectional view showing a main part of the power transmission device shown in FIG. 1;

FIG. 3 is a longitudinal cross-sectional view showing an equivalent friction diameter and a thread section effective diameter in the main part of the power transmission device shown in FIG. 2;

FIG. 4 is a longitudinal cross-sectional view showing an adapter that is used in the power transmission device shown in FIG. 1;

FIG. 5 is a longitudinal cross-sectional view showing a power transmission device that is a second embodiment of the present invention;

FIG. 6 is an enlarged cross-sectional view showing a main part of the power transmission device shown in FIG. 5;

FIG. 7 is a longitudinal cross-sectional view showing an equivalent friction diameter in the main part of the power transmission device shown in FIG. 5;

FIG. 8 is a longitudinal cross-sectional view showing an example of how to secure a washer to a spacer in the power transmission device shown in FIG. 5;

FIG. 9 is a longitudinal cross-sectional view showing another example of how to secure a washer to a spacer in the power transmission device shown in FIG. 5;

FIG. 10 is a longitudinal cross-sectional view showing an example of how to secure a washer to an adapter in the power transmission device shown in FIG. 5;

FIG. 11 is a longitudinal cross-sectional view showing another example of how to secure a washer to an adapter in the power transmission device shown in FIG. 5;

FIG. 12 is a longitudinal cross-sectional view showing a main part of a power transmission device that is a third embodiment of the present invention;

FIG. 13 is an enlarged cross-sectional view showing a portion of the main part of the power transmission device shown in FIG. 12;

FIG. 14 is a cross-sectional view showing a case in which a friction surface between an adapter and a spacer is normal to an axis line in a power transmission device;

FIG. 15 is a cross-sectional view showing a force component applied to a tapered friction surface between an adapter and a spacer in the power transmission device shown in FIG. 12;

FIG. 16 is a longitudinal cross-sectional view showing an example in which a friction surface between an adapter and a spacer is formed reverse-tapered in the power transmission device shown in FIG. 12;

FIG. 17 is a cross-sectional view showing an example in which a plane perpendicular to the axis is formed on a tapered friction surface in the power transmission device shown in FIG. 12;

FIG. 18 is a cross-sectional view showing a state in which no excessive axial force is applied to the tapered friction surface shown in FIG. 17;

FIG. 19 is a longitudinal cross-sectional view showing a power transmission device in relation to the present invention; and

FIG. 20 is a longitudinal cross-sectional view showing a main part of the power transmission device shown in FIG. 19.

### DESCRIPTION OF THE PREFERRED EMBODIMENTS

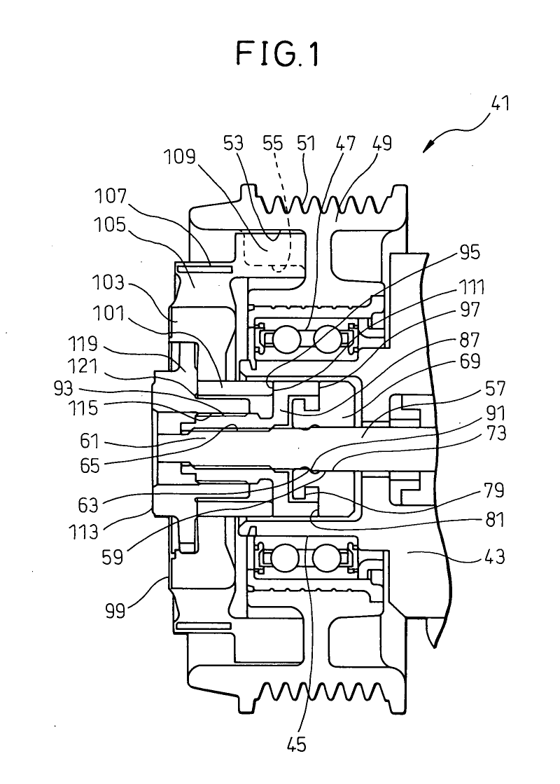

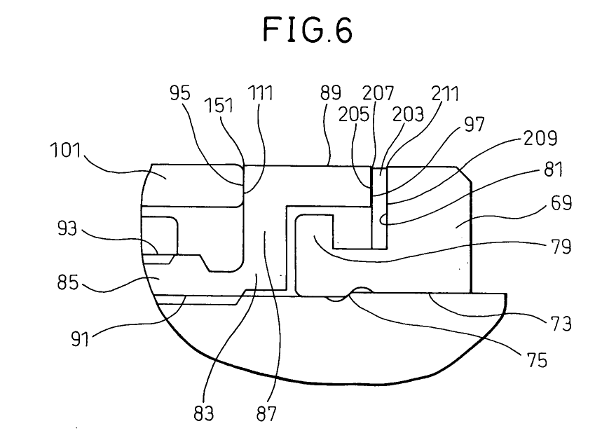

Hereinafter, the embodiments of the present invention will be described with reference to FIGS. 1-18.

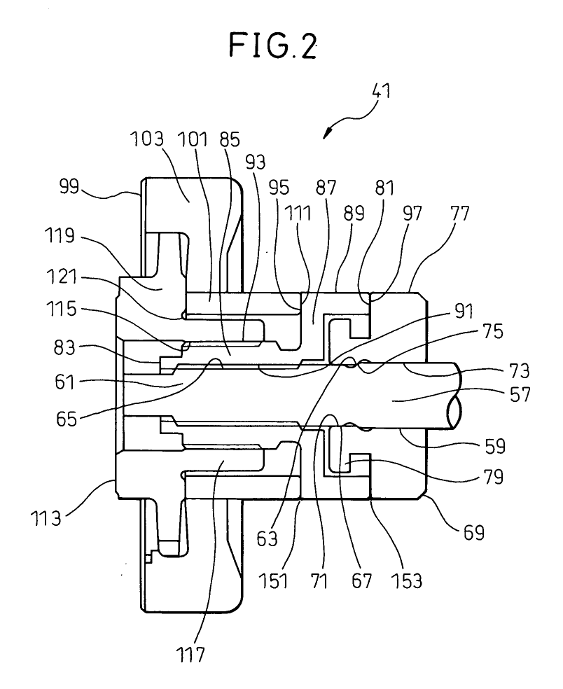

FIGS. 1 and 2 show a power transmission 41 that is a first embodiment of the present invention. The power transmission device 41 is attached to a compressor housing 43 and a tubular bearing support section 45 is provided at a front side of the housing 43. A pulley 49 is supported on an outer circumference of the bearing support section 45 via a radial bearing 47. A belt groove 51 is formed on an outer circumference of the pulley 49 and a belt is wound around the belt groove 51 so that rotational torque is transmitted from a vehicle engine and the like. An annular pocket 53 is formed at a front side of the pulley 49, and a pulley-side engagement section 55 that has concaves and convexes in a radial direction is formed on an inner circumferential surface of the annular pocket 53.

On the other hand, an input shaft 57 that transmits power to the compressor within the housing 43 is supported inside the tubular bearing support section 45. The input shaft 57 has: a large diameter section 59 adjacent to the compressor; a small diameter section 61 that has a diameter slightly smaller than that of the large diameter section 59; and a shoulder section 63 that is formed between the small diameter section 61 and the large diameter section 59 and that increases its diameter from its front side toward its rear side. Then, the small diameter section 61 has: a male thread section 65 that is formed on its front-side outer circumference; and a small diameter section outer circumferential surface 67 that is formed on its rear-side outer circumference.

An annular spacer 69 is inserted around the small diameter section outer circumferential surface 67 of the small diameter section 61 and a front-side outer circumferential surface of the large diameter section 59. The spacer 69 has on its inner circumference: a small diameter inner circumferential surface 71 that is formed near its front side; a large diameter inner circumferential surface 73 that is formed near its rear side; and a shoulder section 75 that is formed between the small diameter inner circumferential surface 71 and the large diameter inner circumferential surface 73 and that increases its diameter from its front side toward its rear side. Further, the spacer 69 has on its outer circumference: a large diameter section 77 that is formed near its rear side; and a hook section 79 that is formed near its front side. Still further, a spacer bearing surface 81 is formed at a front side of the large diameter section 77.

Then, the spacer 69 is disposed so that the small diameter inner circumferential surface 71 is fitted around the small diameter outer circumferential surface 67, the shoulder section 75 is engaged with the shoulder section 63, and the large diameter inner circumferential surface 73 is press-fitted around the large diameter section 59.

Further, the male thread section 65 of the input shaft 57 is provided with an adapter 83. The adapter 83 has: a tubular small diameter section 85; an extended diameter section 87 that is formed at a rear side of the tubular small diameter section 85; and a large diameter section 89 that tubularly extends rearward from an outer circumference of the extended diameter section 87.

The tubular small diameter section 83 has: a female thread section 91 that is formed on its inner circumferential surface; and a male thread section 93 that is formed on its outer circumferential surface. Further, the large diameter section 89 has: a front-side adapter bearing surface 95 that is formed at its front side; and a rear-side adapter bearing surface 97 that is formed at its rear side.

Then, the adapter 83 is mounted on the input shaft 57 so that the female thread section 91 is screwed to the male thread section 65 of the input shaft 57 and the rear-side adapter bearing surface 97 abuts against the spacer bearing surface 81.

A hub 99 is inserted around the small diameter section 85 of the adapter 83 described above. The hub 99 has: a spool 101 that is provided at its innermost position; an inner hub 103 that is disposed outward of the spool; a cylindrical damper 105 that is comprised of an elastic body formed outward of the inner hub 103; an outer ring 107 that is provided outward of the cylindrical damper 105; and a hub-side engagement section 109 that is comprised of an elastic body formed at a rear side of the outer ring 107. The spool 101 is formed to be tubular and it has a hub-side bearing surface 111 formed at its rear side.

Then, the hub 99 is disposed so that the spool 101 is inserted around the small diameter section 85 of the adapter 83 and the hub-side bearing surface 111 abuts against the front-side adapter bearing surface 95 of the adapter 83. Further, the hub-side engagement section 109 of the hub 99 is engaged with the pulley-side engagement section 55 so as to receive power from the pulley 49.

A power interruption member 113 is inserted around the small diameter section 85 of the adapter 83. The power interruption member 113 has: a tubular section 117 that has a female thread section 115 formed on its inner circumference; a flange section 119 that is provided at a front side of the tubular section 117; and a rupture section 121 that is formed between the flange section 119 and tubular section 117.

Then, the power interruption member 113 is mounted so that the female thread section 115 is screwed with the male thread section 93, the flange section 119 is pressed against a front side of the spool 101 of the hub 57, and the hub-side bearing surface 111 of the hub 57 is pressed against the front-side adapter bearing surface 95.

The power interruption member 113 described above operates as follows. Thus, when an excessive load is applied due to seizure of the compressor and the like, a relative rotation occurs between the power interruption member 113 and the adapter 83, and in response to this relative rotation, a large tensile force resulting from the screw engagement between the male thread section 93 and the female thread section 115 is applied between the flange section 119 and the tubular section 117 of the power interruption member 113. This tensile force ruptures the rupture section 121 between the flange section 119 and the tubular section 117, so that the hub 57 is no longer pressed against the adapter 83. As a result, the power transmission from the hub 57 to the adapter 83 is interrupted so as to prevent damage of the power source.

In this configuration, in the power transmission device 41, assuming that a friction coefficient of a front-side abutment surface 151 between the hub-side bearing surface 111 and the front-side adapter bearing surface 95 is μw1 and a friction coefficient of a rear-side abutment surface 153 between the rear-side adapter bearing surface 97 and the spacer bearing surface 81 is μw2, a relationship μw1<μw2 is established.

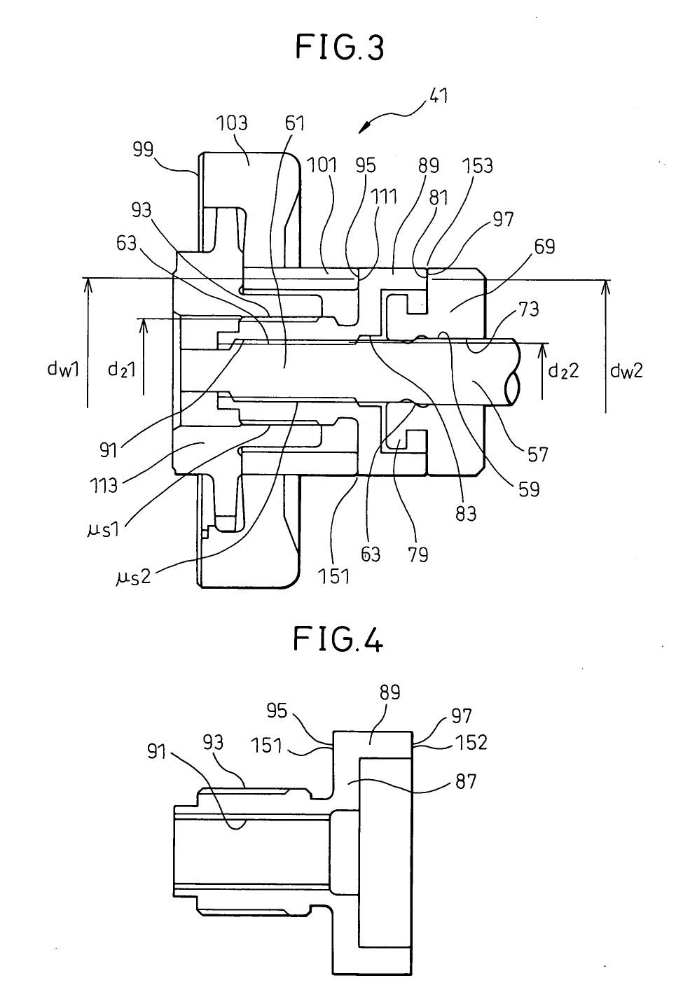

In the power transmission device 41 shown in FIGS. 1 and 2, the hook section 79 that is needed at the time of disassembly is formed at the front side of the spacer 69, and therefore, as shown in FIG. 3, an equivalent friction diameter dw1 of the front-side abutment surface 151 is substantially comparable to an equivalent friction diameter dw2 of the rear-side abutment surface 153. As a result, if μw1=μw2, the both abutment surfaces 151 and 153 have a comparable limiter torque T according to the following equation (1):

T=1/2F[d₂·tan(ρ+β)+d_{w}·μ_{w}] (1)

where
T=limiter torque
F=limiter destruction axial force
d₂=shaft effective diameter
ρ=thread equivalent friction angle μ=tan⁻¹·μₛ/cos α
μₛ=thread surface friction coefficient
α=thread half angle
β=thread lead angle
p=thread pitch angle
μ_{w}=bearing surface friction coefficient
d_{w}=bearing surface equivalent friction diameter

Therefore, when an excessive load is applied, the rear-side abutment surface 153 starts to slip at the same time when the front-side abutment surface 151 starts to slip and relative rotation between the adapter 83 and the power interruption member 113 does not occur. Therefore, the rupture section 121 of the power interruption member 113 does not rupture and the interruption mechanism does not work. In order to avoid such situation, in the power transmission device 41, assuming that the friction coefficient of the front-side abutment-surface 151 is μw1 and the friction coefficient of the rear-side abutment surface 153 is μw2, the relationship μw1<μw2 is established.

In FIG. 3, d₂1 represents an effective diameter of a thread section between the power interruption member 113 and the adapter 83, d₂2 represents an effective diameter of a thread section between the input shaft 57 and the adapter 83, μₛ1 represents a friction coefficient of the thread section between the power interruption member 113 and the adapter 83, and μₛ2 represents a friction coefficient of the thread section between the input shaft 57 and the adapter 83.

More specifically, in the adapter 83 shown in FIG. 4, the front-side adapter bearing surface 95 may be smoother than the rear-side adapter bearing surface 97. Further, a surface treatment may be applied only to the front-side adapter bearing surface 95 so as to have a friction coefficient lower than that of the rear-side adapter bearing surface 97. Here, the surface treatment may be coating of PTFE, molybdenum disulfide, zinc plating, dacrotization, chemical conversion coating, alumite coating and the like. Still further, during assembly, an oil such as grease may be applied on the front-side abutment surface 151 so that the friction coefficient μw1 is smaller than the friction coefficient μw2.

Though the above embodiment has been described with regard to the front-side adapter abutment surface 95 and the rear-side adapter abutment surface 97 of the adapter 83, a similar process can be possible also for the hub-side bearing surface 111 of the hub 99 and the spacer-side bearing surface 81 of the spacer 69 and a similar effect can be obtained.

As described above, in the power transmission device 41 that is the first embodiment of the present invention, the spacer 69 is mounted on the input shaft 57 so that the small diameter inner circumferential surface 71 is fitted around the small diameter outer circumferential surface 67, the shoulder section 75 is engaged with the shoulder section 63, and the large diameter inner circumferential surface 73 is press-fitted around the large diameter section 59. Further, the adapter 83 is mounted on the input shaft 57 so that the rear-side adapter bearing surface 97 of the adapter 83 abuts against the spacer bearing surface 81 of the spacer 69. Then, in this configuration, assuming that the friction coefficient of the front-side abutment surface 151 between the hub-side bearing surface 111 and the front-side adapter bearing surface 95 is μw1 and the friction coefficient of the rear-side abutment surface 153 between the rear-side adapter bearing surface 97 and the spacer bearing surface 81 is μw2, the relationship μw1<μw2 is established.

Therefore, even if an excessive torque is applied and a large axial force is applied to the power interruption member 113 on the adapter 83, so long as the adapter 83 and the spacer 69 do not slip with respect to each other, the axial force is not affected to the adapter 83 and, therefore, in contrast to the conventional art, re-press-fitting of the press-fitted adapter can be prevented.

Further, the friction coefficient μw1 of the front-side abutment surface 151 is configured to be smaller than the friction coefficient μw2 of the rear-side abutment surface 153 and, therefore, it can be prevented that the rear-side abutment surface 153 starts to slip at the same time or before the front-side abutment surface 151 starts to slip. Therefore, the relative rotation between the adapter 83 and the power interruption member 113 can reliably occur so as to rupture the rupture section 121.

Still further, because the re-press-fitting of the adapter 83 can be prevented, rearward movement of the hub 99, and thus, reduction of durability of the bearings can also be prevented. Further, in the case when the hub 99 is engaged with the pulley 49 via an elastic member, interference between the hub 99 and the pulley 49 due to the rearward movement of the hub 99 and a resultant malfunction such as smoke generation and the like can be prevented.

In the power transmission device 41 that is the first embodiment and that is described above with reference to FIGS. 1-4, the re-press-fitting of the adapter 83 can be prevented and, in response to a predetermined torque, the power can be reliably interrupted. However, in this configuration, perpendicularity and flatness of the spacer bearing surface 81 with respect to the axis line of the input shaft 57 is likely to be affected by processing accuracy of the input shaft 57 and the spacer 69. Further, perpendicularity and flatness of the rear-side adapter bearing surface 97 with respect to the axis line of the input shaft 57 is affected by accuracy of the adapter 83 screwed with the male thread section 65 at the tip of the input shaft 57. Because the spacer bearing surface 81 and the rear-side adapter bearing surface 97, whose perpendicularity and the like varies by the processing accuracy, abut against each other, contact of the abutment surfaces is likely to be uneven and an unbalanced load is likely to occur. Further, because the adapter 83 and the spacer 69 are made of high hardness material, an excessive stress due to the unbalanced load is likely to occur, and as a result, the adapter 83 and the spacer 69 may be damaged.

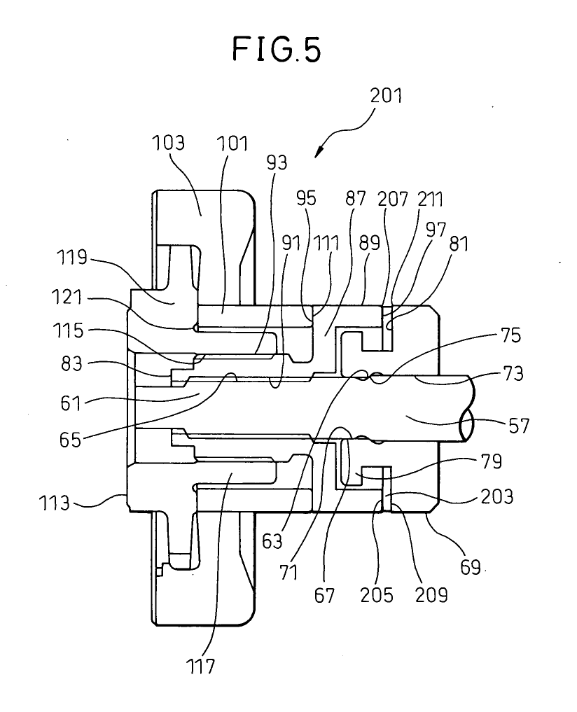

FIGS. 5-11 show a power transmission device 201 of a second embodiment that is made to solve the problems of the first embodiment. In these figures, elements identical to those of the power transmission device 41 shown in FIGS. 1-4 are designated by like reference numerals, the detailed description of which is omitted.

FIG. 5 shows a main part of the power transmission device 201. In the power transmission device 201, a washer 203 is disposed between the rear-side adapter bearing surface 97 of the adapter 83 and the spacer bearing surface 81 of the spacer 69. Then, a front-side contact surface 207 is formed between a front-side washer bearing surface at a front side of the washer 203 and the rear-side adapter bearing surface 97, and on the other hand, a rear-side contact surface 211 is formed between a rear-side washer bearing surface 209 at a rear side of the washer 203 and the spacer-side bearing surface 81.

Relationship of hardness between the washer 203, the adapter 83 and the spacer 69 is established so that hardness of the rear-side adapter bearing surface 97>hardness of the washer 203 and/or hardness of the washer 203<hardness of the spacer bearing surface 81, or otherwise, hardness of the rear-side adapter bearing surface 97<hardness of the washer 203 and/or hardness of the washer 203>hardness of the spacer bearing surface 81.

Here, the adapter 83 is secured by the screw engagement between the male thread section 65 of the input shaft 57 and the female thread section 91 of the adapter 83. Therefore, perpendicularity and flatness of the rear-side adapter bearing surface 97 of the adapter 83 with respect to the axis line of the input shaft 57 depends on accuracy of individual elements. Further, because the spacer 69 is press-fitted around the input shaft 57, perpendicularity and flatness of the spacer bearing surface 81 of the spacer 69 with respect to the axial center of the input shaft 57 also depends on the accuracy of the individual elements. Therefore, if the adapter 83 directly abuts against the spacer 69, a load may be applied unevenly to the contact surfaces due to unevenness of the perpendicularity and flatness and, an excessive stress due to the uneven load may occur and, as a result, the parts may be damaged.

So, in the power transmission device 201, the washer 203 is made softer than the adapter 83 and the spacer 69, or inversely, the washer 203 is made harder than the adapter 83 and the spacer 69, so that the unevenness of the perpendicularity and flatness can be absorbed.

Further, the relationship between the friction coefficient μw1 of the front-side abutment surface 151 between the hub-side bearing surface 111 and the front-side adapter bearing surface 95, the friction coefficient μw3 of the front-side contact surface 207 between the front-side washer bearing surface 205 and the rear-side adapter bearing surface 97, and the friction coefficient μw4 of the rear-side contact surface 211 between the rear-side washer bearing surface 209 and the spacer bearing surface 81 is established so that μw1<μw3 and/or μw1<μw4.

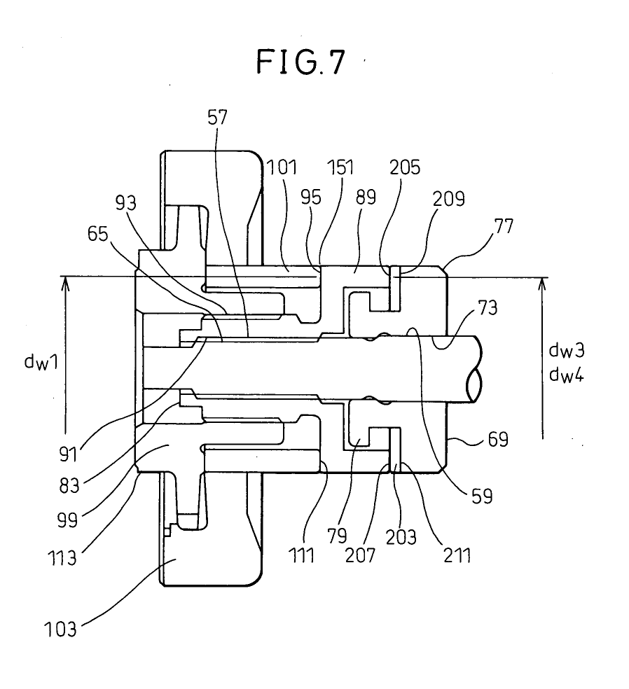

In the power transmission device 201 shown in FIGS. 5 and 7, the hook section 79 that is needed at the time of disassembly is formed at the front side of the spacer 69, and therefore, as shown in FIG. 7, the equivalent friction diameter dw1 of the front-side abutment surface 151, an equivalent friction diameter dw3 of the front-side contact surface 207, and an equivalent friction diameter dw4 are substantially comparable to each other. As a result, if μw1=μw3=μw4, the three abutment and contact surfaces 151, 207 and 211 have a comparable limiter torque T according to the equation (1). Therefore, when an excessive load is applied, the front-side contact surface 207 and the rear-side contact surface 211 start to slip at the same time when the front-side abutment surface 151 starts to slip and, therefore, relative rotation between the adapter 83 and the power interruption member 113 does not occur and the interruption mechanism does not work. Therefore, in order to avoid such a situation, in the power transmission device 201, assuming that the friction coefficient of the front-side abutment surface 151 is awl, the friction coefficient of the front-side contact surface 207 is μw3, and the friction coefficient of the rear-side contact surface 211 is μw4, the relationship μw1<μw3 and/or μw1<μw4 is established.

This condition of the friction coefficient can be easily satisfied by adopting a material having a higher friction coefficient for the washer 203. Further, the surface of the washer 203 may be made rougher than the hub-side bearing surface 111 of the spool 101, or surface treatment such as coating, plating, chemical conversion coating and the like may be applied to the washer. Still further, it is effective that the washer is comprised of a nonferrous metal such as aluminum and copper, an alloy steel, a material coated with rubber or resin, or a non-metallic material.

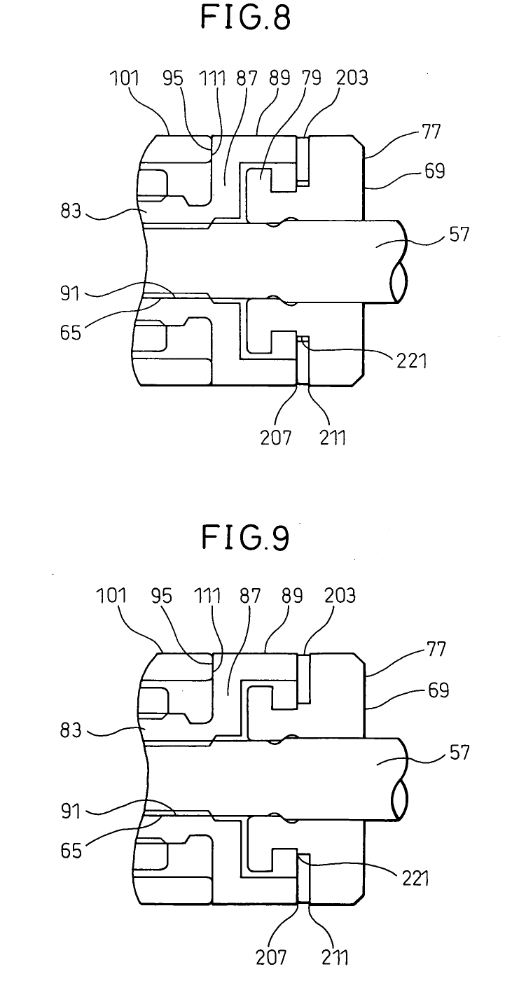

FIGS. 8 and 9 show how to secure the washer. FIG. 8 shows a state in which the washer is faucet-fitted into a washer fitting section 211 formed in the spacer 69 via a minute clearance, whereas FIG. 9 shows a state in which the washer is press-fitted into the washer fitting section 211. As a result, the washer 203 can be coaxial with the spacer 69.

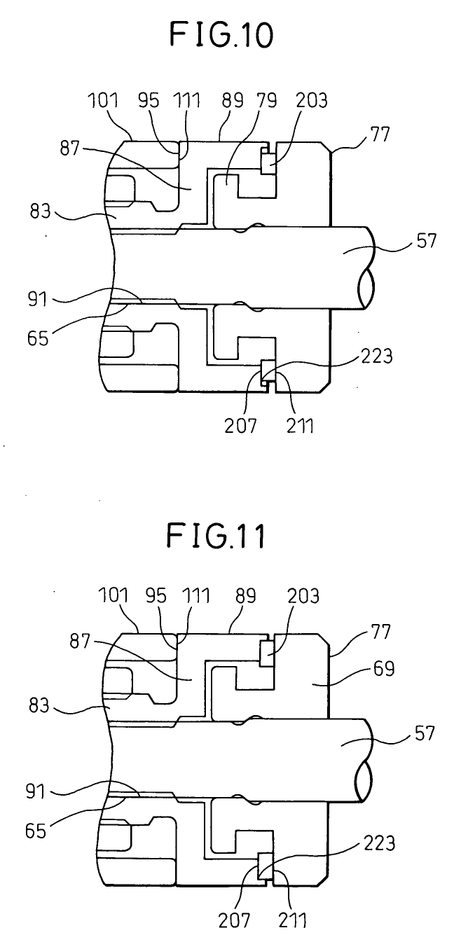

FIGS. 10 and 11 show that the washer is secured to the adapter. FIG. 10 shows a case in which the washer is faucet-fitted into a washer fitting section 223 formed in the rear-side adapter bearing surface 97 of the adapter 83 via a minute clearance, whereas FIG. 11 shows a case in which the washer is press-fitted into the washer fitting section 223. As a result, similar to the cases shown in FIGS. 8 and 9, the washer can be coaxial with the adapter 83.

As described above, in the power transmission device 201, the washer 203 is disposed between the rear-side adapter bearing surface 97 of the adapter 83 and the spacer bearing surface 81 of the spacer 69. Therefore, even if the perpendicularity and flatness of the rear-side adapter bearing surface 97 of the adapter 83 with respect to the axis line is somewhat uneven, or the perpendicularity and flatness of the spacer bearing surface 81 of the spacer 69 with respect to the axis line is somewhat uneven, the washer 203 can absorb the unevenness and, therefore, damage and wear of the parts due to the unbalanced load, partial contact and the like can be prevented.

Further, in the power interruption device 201, assuming that the friction coefficient of the front-side abutment surface 151 is μw1, the friction coefficient of the front-side contact surface 207 is μw3, and the friction coefficient of the rear-side contact surface 211 is μw4, the relationship μw1<μw3 and/or μw1<μw4 is established and, therefore, when an excessive torque is applied, it can be prevented that the front-side contact surface 207 and the rear-side contact surface 211 start to slip at the same time when the front-side abutment surface 151 starts to slip and that the interruption mechanism does not work.

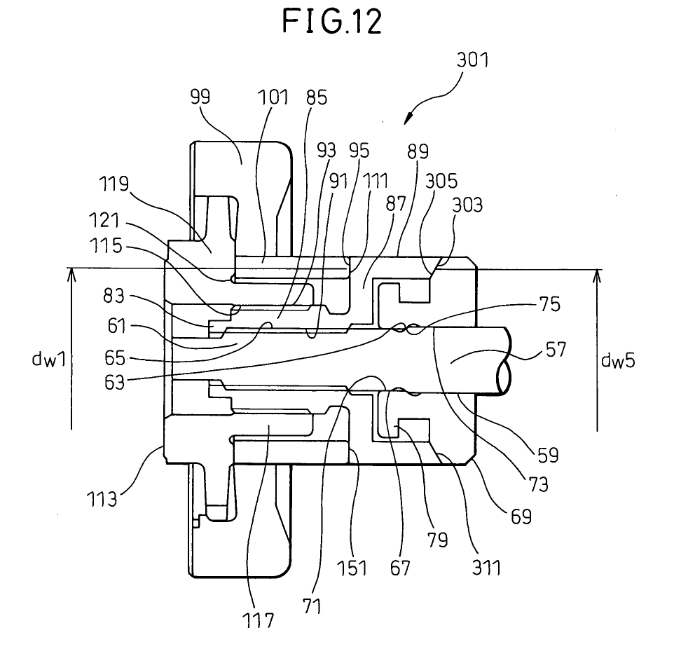

FIGS. 12-18 show a power transmission device 301 that is a third embodiment of the present invention. Similarly to the second embodiment shown in FIGS. 5-11, the third embodiment also improves the contact portions of the adapter and the spacer where the contact of the abutment surface is likely to be uneven and the unbalanced load is likely to occur. In these figures, elements identical to those of the power transmission device 41 shown in FIGS. 1-4 are designated by like reference numerals, the detailed description of which is omitted.

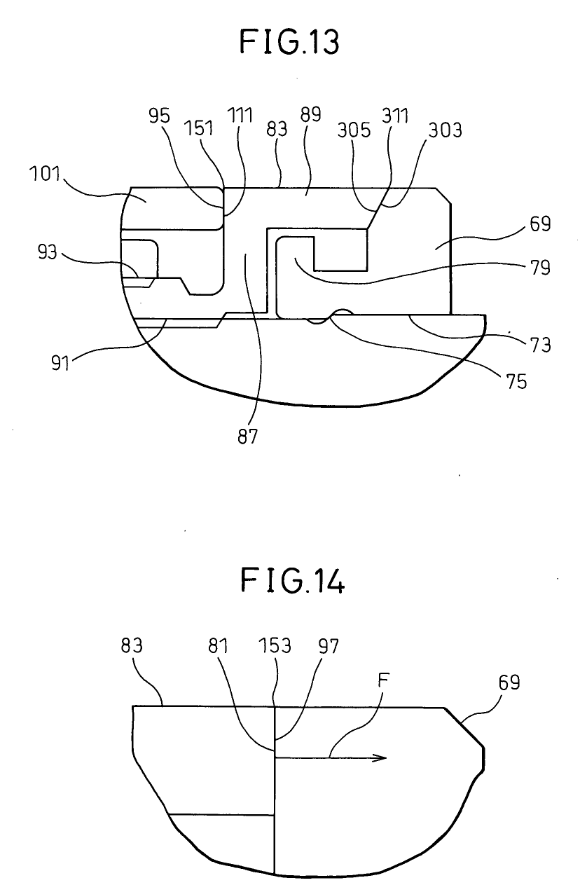

FIG. 12 shows a main part of the power transmission device 301. As shown in FIGS. 12 and 13, a rear-side adapter bearing surface 303 of the adapter 83 and a spacer bearing surface 305 of the spacer 69 are tapered so as to increase their diameters toward the rear side. Thus, the rear-side adapter bearing surface 303 and the spacer bearing surface 305 are tapered, and therefore, when an excessive axial force is applied due to seizure of the compressor and the like, the tapered surfaces are strongly fitted into each other to increase binding force. Further, due to a wedge effect of the tapered surfaces, the unevenness of the abutment surface can be corrected and the occurrence of the unbalanced load can be prevented.

In this connection, in the power transmission device 301 shown in FIGS. 12 and 13, the hook section 79 that is needed at the time of disassembly is formed at the front side of the spacer 69, and therefore, as shown in FIG. 12, the equivalent friction diameter dw1 of the front-side abutment surface 151 is substantially comparable to an equivalent friction diameter dw5 of the rear-side abutment surface 311. As a result, if the friction coefficient μw1 of the front-side abutment surface 151 is equal to the friction coefficient μw5 of the rear-side abutment surface 311, the both abutment surfaces 151 and 311 have a comparable limiter torque T according to the equation (1). Therefore, when an excessive load is applied, the rear-side contact surface start to slip at the same time when the front-side abutment surface starts to slip and the interruption mechanism does not work.

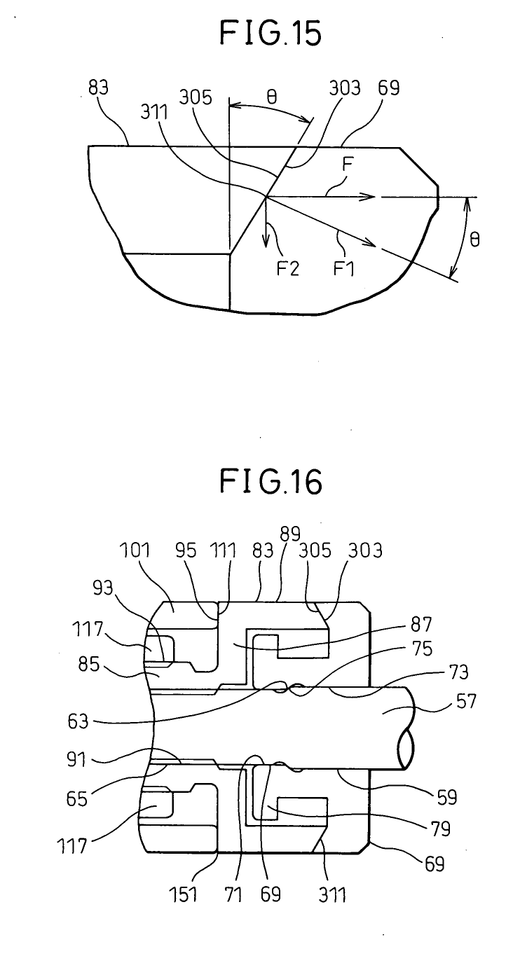

However, in the power transmission device 301, the rear-side adapter bearing surface 303 and the spacer bearing surface 305 are tapered and, therefore, as shown in FIG. 15, the axial force F generated due to the excessive torque at the time of seizure of the compressor can be broken down into a reaction force F1 perpendicular to the bearing surface and a radial binding force F2. Assuming that the tapered angle is θ, the following equations hold:

F1=F/cos θ, F2=F tan Θ

The friction force f5 of the bearing surface can be calculated by multiplying the friction coefficient μw5 by the axial force F1:

f5=μw5F1=μw5F/cos θ

and, as a result, F1 is larger than F. Therefore, even if μw1=μw5, the friction force f5 of the rear-side abutment surface 311 is larger than the friction force f1 of the front-side abutment surface 151. Therefore, when the excessive torque is applied, the rear-side abutment surface 311 can be prevented from slipping at the same time when the front-side abutment surface 151 starts to slip and the interruption mechanism can work properly.

Further, because the rear-side adapter bearing surface 303 and the spacer bearing surface 305 are tapered, the radial binding force F2 is generated and acts as a press-fitting load to press the tapered surfaces against each other. Therefore, the tapered surfaces are strongly fitted into each other by the reaction force F1 and the binding force F2.

FIG. 14 shows a case in which the rear-side adapter bearing surface 303 and the spacer bearing surface 305 are not tapered. In this case, only μw2F that is the product of the axial force F and μw2 acts as the binding force, and unlike the case when the bearing surfaces are tapered, a large binding force cannot be expected.

Here, the tapered angle θ can be between −85° and −5° or between +5° and +85° and FIG. 16 shows a case in which the bearing surfaces are tapered so as to decrease their diameters toward the rear side, which has similar effects.

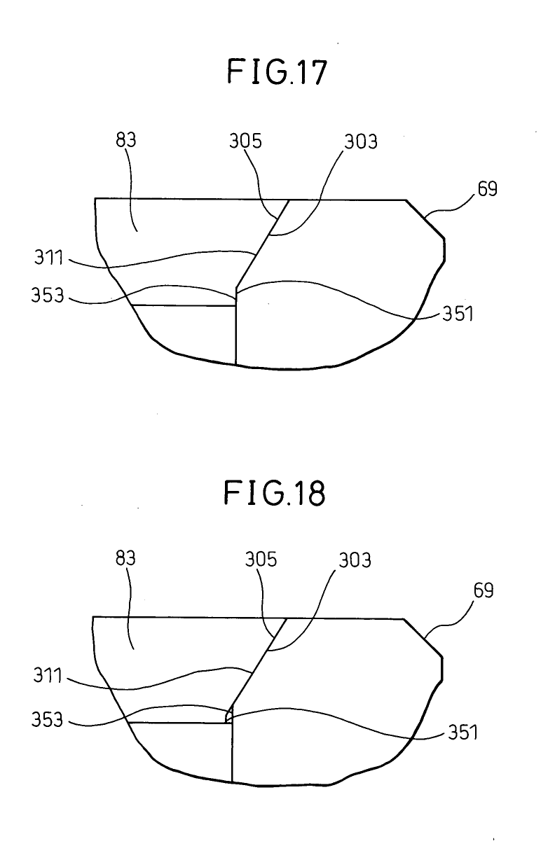

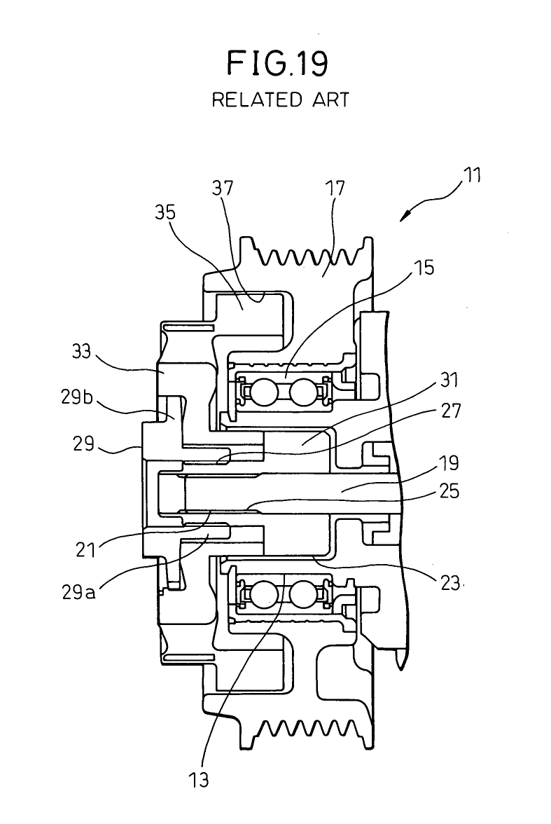

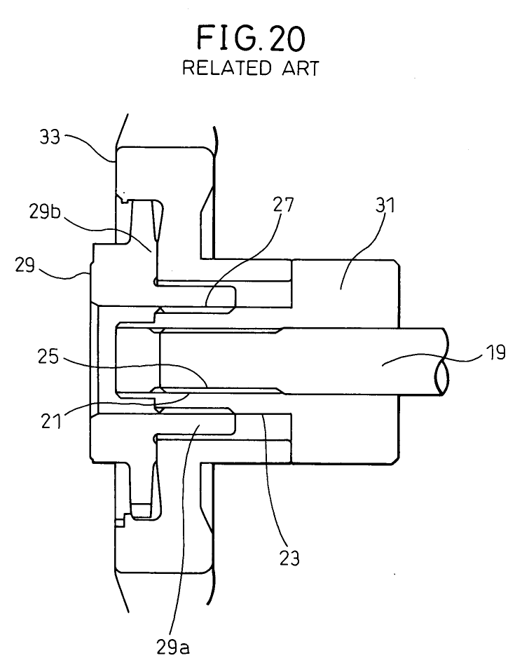

FIG. 17 shows a case in which a portion of the tapered rear-side abutment surface 311 is flattened. More specifically, an adapter-side flat surface 351 that is perpendicular to the axis line of the adapter 83 is formed inside the rear-side adapter bearing surface 303, and a spacer-side flat surface 353 that is perpendicular to the axis line of the spacer 69 is formed inside the space bearing surface 305.

When an excessive torque occurs due to the seizure of the compressor and the like and the adapter 83 is pressed against the spacer 69 by the excessive axial force, due to deformation of the adapter 83 and the spacer 69, the adapter 83 axially displaces slightly with respect to the spacer 69 and, then, the hub abutting against the adapter also displaces. In particular, when the tapered angle θ is large, the wedge effect increases the displacement so that the hub may interfere with the pulley and the housing. Therefore, the adapter-side flat surface 351 on the rear-side adapter bearing surface 303 and the spacer-side flat surfaces 353 on the spacer bearing surface 305 are formed so that they abut against each other to restrict the axial displacement of the adapter and the spacer.

Further, the adapter-side flat surface 351 and the spacer-side flat surface 353 may be configured so that there is a slight clearance therebetween in normal operation of the compressor as shown in FIG. 18 and they may abut against each other to restrict the axial displacement in response to an excessive load.

As described above, in the power transmission device 301, the rear-side adapter bearing surface 303 of the adapter 83 and the spacer bearing surface 305 of the spacer 69 are tapered, and when the excessive axial force due to the seizure of the compressor and the like is applied, the tapered surfaces are strongly fitted into each other to increase the binding force and, due to the wedge effect of the tapered surfaces, the unevenness of the abutment surfaces can be corrected and the occurrence of the unbalanced load can be prevented.

Further, the rear-side abutment surface 311 where the rear-side adapter bearing surface 303 and the spacer bearing surface 305 abut against each other is inclined with respect to the axis line, and therefore, even if the friction coefficient μw1 of the front-side abutment surface 151 is equal to the friction coefficient μw5 of the rear-side abutment surface 311, the friction force f5 of the rear-side abutment surface 311 is larger than the friction force f1 of the front-side abutment surface 151. Therefore, when the excessive torque is applied, the rear-side abutment surface 311 can be prevented from slipping at the same time when the front-side abutment surface 151 starts to slip and the interruption mechanism can work properly.

Here, though the washer 203 is disposed between the rear-side adapter bearing surface 97 and the spacer bearing surface 81 in the second embodiment shown in FIGS. 5-11 and the rear-side adapter bearing surface 303 and the spacer bearing surface 305 are tapered in the third embodiment shown in FIGS. 12-18, the present invention is not limited to these embodiments and the washer may be provided in the configuration in which the rear-side adapter bearing surface and the spacer bearing surface are tapered.

1. A power transmission device comprising:
an input shaft having a male thread section on its front-side outer circumference;
a spacer press-fitted and secured around a rear-side of the male thread section of this input shaft;
a tubular adapter screwed with the male thread section of said input shaft and friction-coupled with a front side of said spacer, said tubular adapter having a male thread section on its outer circumference;
a hub having an inner circumference being friction-coupled with a front side of the adapter to transmit external power to said adapter; and
a power interruption section having a flange section engaged with said hub and a tubular section screwed with the male thread section of said adapter, said power interruption section pressing the inner circumference of said hub against said adapter to transmit power from said hub to said input shaft,
wherein, in said power interruption section, when an excessive load is applied to a driven apparatus, said tubular section rotates with respect to said adapter to apply a tensile force between said tubular section and said flange section to rupture said tubular section from said flange section, so that a pressing force on said adapter is dissipated and power is interrupted,
wherein when an excessive torque is applied, even if the friction coupling between said adapter and the inner circumference of said hub starts to slip, the friction coupling between said adapter and said spacer remains not to slip.

2. A power transmission device according to claim 1, wherein assuming that an abutment surface between said adapter and said inner circumference of said hub has an equivalent friction diameter dw1 and a friction coefficient μw1 and an abutment surface between said adapter and said spacer has an equivalent friction diameter dw2 and a friction coefficient μw2, if dw1 and dw2 are substantially comparable to each other, a relationship μw1<μw2 is established.

3. A power transmission device according to claim 2, wherein a front-side adapter bearing surface abutting against the inner circumference of said hub is smoother than a rear-side adapter bearing surface abutting against said spacer.

4. A power transmission device according to claim 3, wherein a surface treatment is applied to said front side adapter bearing surface so that said front side adapter bearing surface is smoother than said rear-side adapter bearing surface.

5. A power transmission device according to claim 1, wherein a washer is disposed between said adapter and said the spacer.

6. A power transmission device according to claim 5, wherein, assuming that an abutment surface between said adapter and the inner circumference of said hub has an equivalent friction diameter dw1 and a friction coefficient awl, a contact surface between said adapter and said washer has an equivalent friction diameter dw3 and a friction coefficient μw3, and a contact surface between said washer and said spacer has an equivalent friction diameter dw4 and a friction coefficient μw4, when dw1, dw3 and dw4 are substantially comparable to each other, a relationship μw1<μw3 and μw1<μw4 is established.

7. A power transmission device according to claim 1, wherein an abutment surface between said adapter and said spacer is tapered.

8. A power transmission device according to claim 7, wherein said abutment surface is formed to increase its diameter from its front side toward its rear side.

9. A power transmission device according to claim 7, wherein said abutment surface is formed to reduce its diameter from its front side toward its rear side.
